(19) United States
(12) Patent Application Publication
(10) Pub. No.: US 2015/0242722 A1
(43) Pub. Date: Aug. 27, 2015

(54) IMAGE PROCESSING CONDITION SETTING PROGRAM, IMAGE PROCESSING CONDITION SETTING METHOD, AND IMAGE PROCESSING DEVICE

(71) Applicant: Oki Data Corporation, Tokyo (JP)

(72) Inventor: Nobuyuki WATANABE, Tokyo (JP)

(21) Appl. No.: 14/629,818

(22) Filed: Feb. 24, 2015

(30) Foreign Application Priority Data
Feb. 27, 2014 (JP) 2014-036761

(51) Int. Cl. G06K 15/02; G06K 15/00

(52) U.S. Cl. CPC G06K 15/1806; G06K 15/007

(57) ABSTRACT

A program for setting an image processing condition includes: a store unit to store a first identifier of an image data output unit whose image processing condition including plural print setting items is to be set; a first input unit to prompt a user to input first setting information on a first print setting item for the image data output unit having the first identifier; a second input unit to prompt the user to input second setting information on a second print setting item for the image data output unit having the first identifier; an identifier providing unit to provide a second identifier, which is an identification name of the image processing condition having the first and second setting information inputted; and a registration unit to register the image processing condition having the second identifier, in connection with the first identifier, in a setting-information storage as a readable storage.

### CROSS REFERENCE TO RELATED APPLICATIONS

This application claims priority based on 35 USC 119 from prior Japanese Patent Application No. 2014-036761 filed on Feb. 27, 2014, entitled “IMAGE PROCESSING CONDITION SETTING PROGRAM, IMAGE PROCESSING CONDITION SETTING METHOD, AND IMAGE PROCESSING DEVICE”, the entire contents of which are incorporated herein by reference.

### BACKGROUND OF THE INVENTION

1. Field of the Invention

The present disclosure relates to an image processing condition setting program, an image processing condition setting method, and an image processing device.

2. Description of Related Art

In image processing devices in the related art, when a user orders printing of a target document by right-clicking the icon thereof, the document is printed in accordance with predetermined print settings (for example, see Japanese Patent Application Publication No. 2010-79599).

### SUMMARY OF THE INVENTION

However, since printing is performed in accordance with predetermined print settings in the related art, a user cannot know a printing result beforehand, and may fail to obtain a printing result which the user desires.

An embodiment of the invention enables a user to obtain a desired printing result by a simple operation.

An aspect of the invention provides a program for setting an image processing condition that includes: a store unit configured to store a first identifier, which is identification information of an image data output unit whose image processing condition including plural print setting items is to be set, the image data output unit being configured, based on the image processing condition, to output image data to an output destination corresponding to the image data output unit; a first input unit configured to prompt a user to input first setting information, which is setting information on a first print setting item of the image processing condition for the image data output unit having the first identifier; a second input unit configured to prompt the user to input second setting information, which is print setting information on a second print setting item, different from the first print setting item, of the image processing condition for the image data output unit having the first identifier; an identifier providing unit configured to provide a second identifier, which is an identification name of the image processing condition having the first and second setting information inputted through the first and second input units; and a registration unit configured to register the image processing condition having the second identifier, in connection with the first identifier, in a setting-information storage as a readable storage.

According to the aspect of the invention, a user's desired printing result may be obtained by a simple operation.

### BRIEF DESCRIPTION OF THE DRAWINGS

FIG. 1 is a block diagram illustrating the configuration of an image processing system in a first embodiment;

FIG. 2 is a flow chart illustrating the processing flow of a print option setting in the first embodiment;

FIG. 3 is an explanatory diagram of a print option setting screen in the first embodiment;

FIG. 4 is an explanatory diagram illustrating the configuration of a setting-information table in the first embodiment;

FIG. 5 is a flow chart illustrating the processing flow of printing in the first embodiment;

FIG. 6 is an explanatory diagram of a setting selection in the first embodiment;

FIG. 7 is a block diagram illustrating the configuration of an image processing system in a second embodiment;

FIG. 8 is a flow chart illustrating the processing flow of a print option setting in the second embodiment;

FIG. 9 is an explanatory diagram of a print option setting screen in the second embodiment;

FIG. 10 is an explanatory diagram illustrating the configuration of a setting-information table in the second embodiment;

FIG. 11 is a flow chart illustrating the processing flow of printing in the second embodiment; and

FIG. 12 is an explanatory diagram of a setting selection in the second embodiment.

### DETAILED DESCRIPTION OF EMBODIMENTS

Descriptions are provided hereinbelow for embodiments based on the drawings. In the respective drawings referenced herein, the same constituents are designated by the same reference numerals and duplicate explanation concerning the same constituents is omitted. All of the drawings are provided to illustrate the respective examples only.

Hereinafter, embodiments of an image processing condition setting program, an image processing condition setting method, and an image processing device according to the invention are described with reference to the drawings.

### First Embodiment

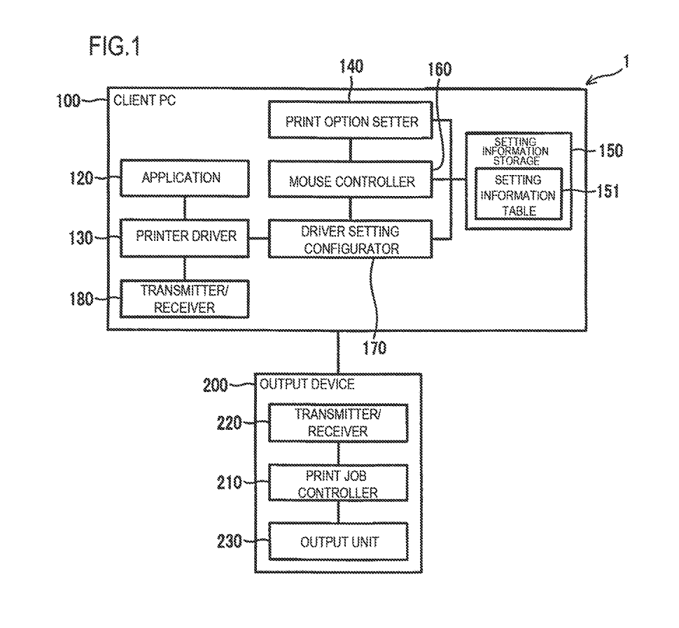

FIG. 1 is a block diagram illustrating the configuration of an image processing system in a first embodiment.

In FIG. 1, image processing system 1 includes client computer (hereinafter referred to as “client PC”) 100 serving as an image processing device that issues a command for printing, and output device 200 serving as an image formation device that is communicatively connected to client PC 100 via a communication line. In this embodiment, output device 200 is described as a printer.

Client PC 100 includes application (software) 120, printer driver (software) 130, print option setter 140, setting-information storage 150, mouse controller 160, driver setting configurator 170, and transmitter/receiver 180.

Application 120 is application software such as document generation software or spreadsheet software, and manages the generation of print data upon receiving a print command.

Printer driver 130 as an image data output unit is activated by application 120 and performs image processing to generate print data as image data. One printer driver 130 is provided for each output device 200. When plural output devices 200 are connected to client PC 100, plural printer drivers 130 are provided accordingly.

Print option setter 140 receives an operation of a user via an input interface (for example, a mouse) and registers any print condition (image processing condition) as print option setting information.

Print option setter 140 has a function as a first input unit that asks (prompts) a user to input first setting information (for example, setting information on performing double-sided printing) related to a first print setting item (for example, double-sided print/single-sided print). In addition, print option setter 140 has a function as a second input unit that asks a user to input second setting information (for example, setting information on performing long-side binding) related to a second print setting item (binding side) different from the first print setting item (for example, double-sided print/single-sided print).

Print option setter 140 also has a function as an identifier providing unit that asks (prompts) a user to provide a print condition (image processing condition) with a “setting name” serving as an identifier (a second identifier or a second identification name) of the print condition. By using the setting name, the first setting information (for example, setting information on performing double-sided printing) and the second setting information (for example, setting information on performing long-side binding) inputted by a user are associated with each other and registered as the print condition.

Setting-information storage 150 as a readable storage stores (registers) setting information on each print setting item inputted by print option setter 140, into setting-information table 151.

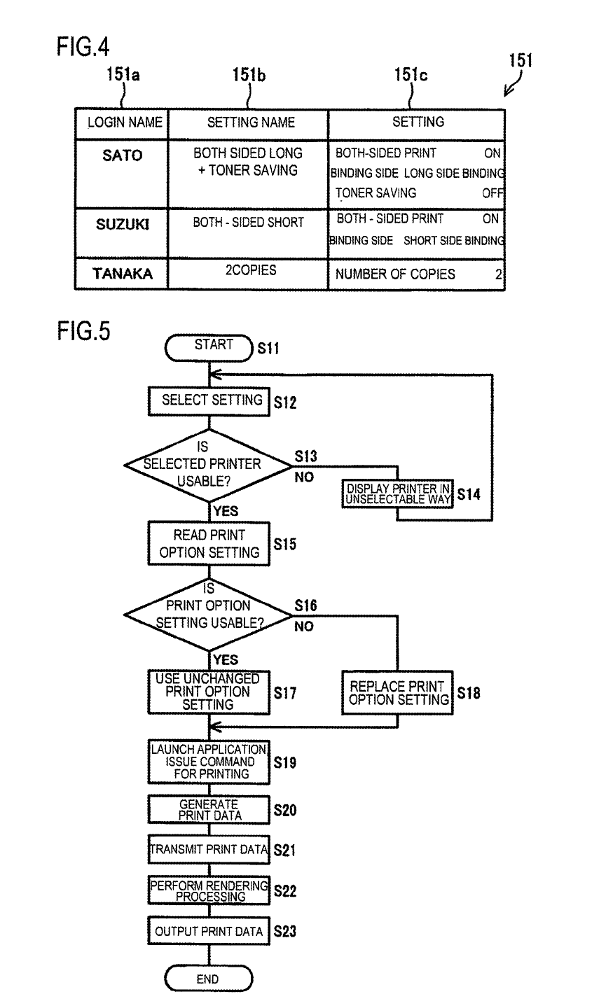

For example, as illustrated in FIG. 4, setting-information table 151 stores “login name” 151a as the identification information of a user, and “setting name” 151b as the identifier of the set print condition and “setting” 151c as the setting items in the print condition in connection with “login name” 151a.

Here, setting-information table 151 is provided for each printer driver 130 and is stored in setting-information storage 150 for a corresponding printer driver name (for example, PRINTER-1, PRINTER-2, etc.) as a first identifier.

Print option setter 140 receives an operation of a user via a user interface (for example, a mouse), and adds or deletes “setting name” 151b and “setting” 151c as the print setting items which are to be registered in setting-information table 151.

In this manner, print option setter 140 has a function as a registration unit that registers a print condition in readable setting-information storage 150 for each printer driver name, the print condition (image processing condition) including the first setting information (for example, setting information on performing double-sided printing) and the second setting information (for example, setting information on performing long-side binding).

Mouse controller 160 serving as a selection unit controls a mouse which is an input interface, and receives a mouse operation of specifying a print target document and/or a print option setting (print condition) registered in setting-information storage 150. Mouse controller 160 has a function as a display unit that upon receiving an operation by a user to select a print target document, selectably displays print option settings (print conditions) set in setting-information table 151 as a print option setting selection screen.

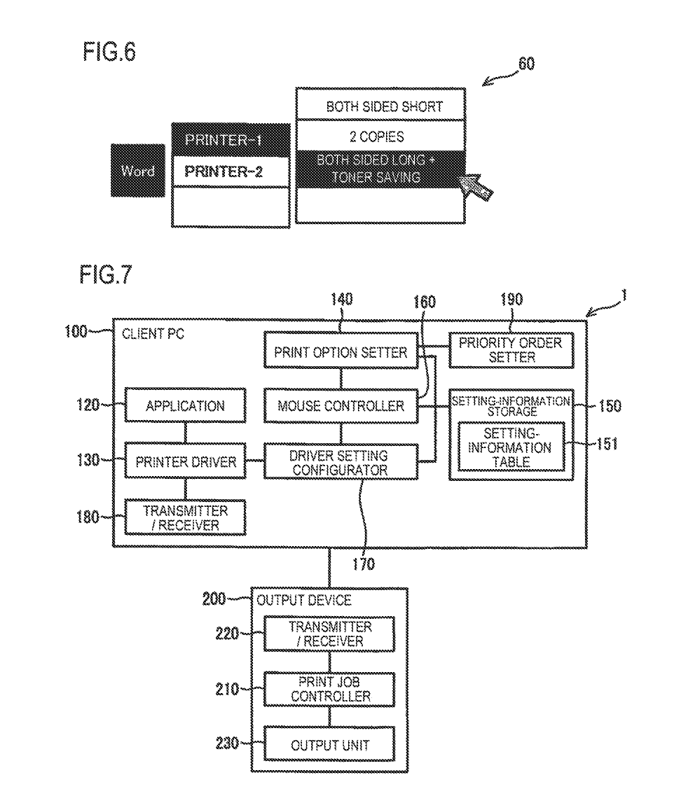

Upon receiving an operation (for example, right-clicking) by a user to select a document, mouse controller 160 displays the name (printer driver name) of a printer for printing the document and the setting name as the identifier of a print option setting on the print option setting selection screen illustrated in FIG. 6. The setting names to be displayed are of “setting name” 151b of the print option settings set in setting-information table 151 illustrated in FIG. 4.

Therefore, the number of the setting names displayed on the print option setting selection screen increases/decreases as the number of the print option settings (print conditions) set in setting-information table 151 increases/decreases.

Driver setting configurator 170 defines the print condition for printer driver 130 as the print option setting in setting-information storage 150, specified by mouse controller 160. Driver setting configurator 170 functions as an input unit that calls printer driver 130 in connection with a setting name selected by mouse controller 160 and inputs to printer driver 130, the first setting information (for example, double-sided print), the second setting information (for example, binding side), and information on a print target document, selected by mouse controller 160.

Printer driver 130 performs image processing on the information of a print target document, selected by mouse controller 160, based on the inputted first setting information (for example, double-sided print) and second setting information (for example, binding side), and outputs the image-processed information as print data (image data).

Transmitter/receiver 180 communicates with each output device 200, and outputs the print data generated by printer driver 130 to output device 200 and receives information related to the status of the device from output device 200. Thus, transmitter/receiver 180 has a function as an acquisition unit that acquires information on the status of a printer (output device 200) which is an output destination of the print data generated by printer driver 130.

Output device 200 includes print job controller 210 that controls the processing of the entire device based on a print job, transmitter/receiver 220 that transmits and receives data to and from client PC 100 and inputs print data as the print job, and output unit 230 that outputs an image generated from the print data.

The operation of the above-mentioned configuration is described.

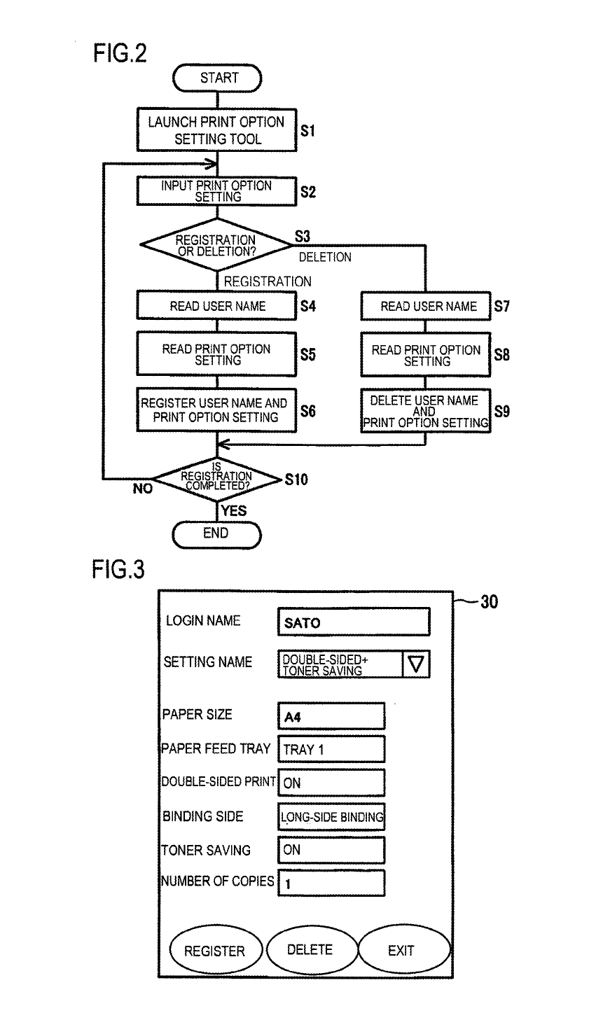

First, the processing of the print option setting performed by the image processing system is described with reference to FIG. 1 in accordance with the steps in FIG. 2 prefixed with the letter S in the flow chart illustrating the processing flow of print option setting in the first embodiment of FIG. 2.

S1: An operation of a user causes client PC 100 to launch a print option setting tool that is software for performing the print option setting. At this point, client PC 100 specifies printer driver 130 that performs the print option setting, launches the print option setting tool, and stores the printer driver name in setting-information storage 150.

Print option setter 140 of client PC 100, which has launched the software for performing the print option setting, displays a print option setting screen on a display unit such as a display to prompt a user to set each print setting item. The print option setting screen is, for example, print option setting screen 30 illustrated in FIG. 3, and displays each setting item in the print option setting. That is, print option setting screen 30 displays “login name” for identifying a user and “setting name” as an identifier for identifying a print option setting (print condition) as illustrated in FIG. 3. In addition, as illustrated in FIG. 3, print option setting screen 30 displays print setting items such as “paper size” that specifies a size of paper to be printed, “paper feed tray” that specifies a paper feed tray that feeds paper, “double-sided print” that specifies double-sided print or single-sided print, “binding side” that specifies a side for binding, “toner saving” that specifies less toner consumption, and “number of copies” that specifies the number of printed copies. In addition, print option setting screen 30 has a “registration” button for registering (storing) setting information in setting-information storage 150 that is selected by the user for each print setting item, a “deletion” button for deleting already registered setting information from setting-information storage 150, and an “exit” button for exiting from print option setting screen 30. Here, “double-sided print” and “toner saving” are set to be performed in FIG. 3.

S2: Print option setter 140 receives an operation by a user to input a setting name and each setting item in the print option setting on the displayed print option setting screen via an input interface such as a keyboard, a mouse, or a touch panel.

In this manner, print option setter 140 prompts a user to input (a first input step) the first setting information (for example, information on performing double-sided printing) related to the first print setting item (for example, double-sided print/single-sided print), then prompts a user to input (a second input step) the second setting information (for example, information on performing long-side binding) related to the second print setting item (binding side) different from the first print setting item (for example, double-sided print/single-sided print).

In addition, print option setter 140 prompts a user to provide a “setting name” to a print option setting (print condition) having the user-selected first setting information (for example, information on performing double-sided printing) and second setting information (for example, information on performing long-side binding), the setting name serving as an identifier (the second identifier) of the print option setting (identifier providing step).

S3: Print option setter 140 determines whether the “registration” button or the “deletion” button is pressed on the print option setting screen. When it is determined that the “registration” button is pressed, the processing proceeds to S4. When it is determined that the “deletion” button is pressed, the processing proceeds to S7.

S4: Print option setter 140, which determines that the “registration” button is pressed, reads a login name that is inputted on the print option setting screen as a user name.

S5: Print option setter 140 further reads the setting name and the setting information in the print option setting (print condition) inputted on the print option setting screen.

S6: Print option setter 140 stores (registers) the read login name, setting name, and setting information as “setting name” 151b and “setting” 151c in setting-information storage 150 in connection with “login name” 151a of setting-information table 151, and the processing proceeds to S10.

In this manner, print option setter 140 registers a print option setting (print condition), with which a printer driver name, the first setting information (for example, information on performing double-sided printing) and the second setting information (for example, information on performing long-side binding) are associated with each other, together with a setting name as an identifier in readable setting-information storage 150 (registration step).

Here, an example of a method of registering the print option setting (print condition) is described.

For example, when the operating system of client PC 100 is Windows (registered trademark), left double-clicking of the icon of “print option setting tool” by a user causes print option setting screen 30 illustrated in FIG. 3 to be displayed, thereby allowing a user to input a login name, a setting name, and setting information on each print setting item via print option setting screen 30.

When a login name, a setting name, and setting information on each print setting item are inputted by a user, the inputted login name, setting name, and setting information on each print setting item are saved in “C: \User\[login_name]\AppData\Roaming\Microsoft\Windows\SendTo\[printer name]” as information (for example, a batch file) in coordination with the print option setting tool.

When a batch file is saved, a storage area that stores a print option setting tool program file called “print option setting tool.exe” is set in connection with the batch file with parameters to be passed to the “print option setting tool.exe” and a print target document, selected by right-clicking.

An example of a batch file is given by “‘C:\Program File\print option setting tool.exe’ %1/PRINTER-1/double-sided printing/long-side binding/toner saving/tool priority.” The batch file is saved and registered under the file name of “PRINTER-1_double-sided length+toner saving.bat” in the folder at C:\User\[login_name]\AppData\Roaming\Microsoft\Windows\SendTo \PRINTER-1.

A name for the selected printer name and parameters is automatically provided to the file name of a batch file to be registered, but the file name may be changed and registered by a user later.

Also “C:\Program File\print option setting tool.exe” indicates a storage area where the program file of print option setting tool called “print option setting tool.exe” is stored. “/PRINTER-1” is a print setting parameter which is passed to the print option setting tool and which indicates the setting that selects a print output destination corresponding to PRINTER-1. “%1” is a print setting parameter which is passed to the print option setting tool and which indicates a variable that carries information (for example, the file storage location\file-name.extension) on the file of a print target document, previously selected by right-clicking. “/Double-sided print” is a print setting parameter which is passed to the print option setting tool and which indicates the setting that commands to perform double-sided printing. “/Long-side binding” is a print setting parameter which is passed to the print option setting tool and which indicates the setting that commands to perform long-side binding. “/Toner save” is a print setting parameter which is passed to the print option setting tool and which indicates the setting that commands to save toner. “/Tool priority” is a print setting parameter which is passed to the print option setting tool and which indicates the setting that complements the print setting information with print setting parameters (print option setting information) previously set in the print option setting.

Similarly, for example “‘C:\Program File\print option setting tool.exe’ %1/PRINTER-1/double-sided printing/short-side binding” may be saved and registered under the file name of “PRINTER-1_double-sided short.bat”, and “‘C:\Program File\print option setting tool.exe’ %1/PRINTER-1/number of copies of 2” may be saved and registered under the file name of “PRINTER-1 number of copies of 2.bat”.

When a user desires to change the print option setting (print condition), a user inputs or selects an already registered batch file name to or from the column of “setting name” on print option setting screen 30 illustrated in FIG. 3. Then the batch file with the batch file name is read and each of the print setting parameters (the setting information) of the read batch file is displayed on a corresponding column of the setting items of print option setting screen 30. When the user selects the “registration” button in this state, the batch file stored in “C:\User\[loginname]\AppData\Roaming\Microsoft\Windows\SendTo \[printer name]” is changed to new print setting parameters.

S7: On the other hand, print option setter 140, which determines that the “deletion” button is pressed in S3, reads a login name that is inputted on the print option setting screen as a user name.

S8: Print option setter 140 further reads the setting name and the setting information on each print setting item inputted on the print option setting screen.

S9: Print option setter 140 erases (deletes) the read login name, setting name, and setting information on each print setting item from setting-information table 151 of setting-information storage 150. The processing then proceeds to S10.

When the print option setting (print condition) is deleted, an already registered batch file name is inputted or selected to or in the column of “setting name” on print option setting screen 30 illustrated in FIG. 3 and the “deletion” button is selected. Then the batch file stored in “C:\User\[login_name]\AppData\Roaming\Microsoft\Windows\SendT o\[printer name]” is deleted.

S10: Print option setter 140 determines whether or not the “exit” button is pressed on the print option setting screen. When the “exit” button is determined to be pressed, the processing is terminated. When the “exit” button is determined not to be pressed, the processing proceeds to S2 to wait for an input.

Next, the processing flow of printing performed by the image processing system in the first embodiment of FIG. 1 is described with reference to the flow chart of FIG. 5. It is assumed that a user has logged in to the image processing system with a predetermined login name.

S11: When the icon of a print document displayed on the display unit is right-clicked on a mouse for commanding printing, mouse controller 160 of client PC 100 of image processing system 1 starts to print the print document.

S12: Mouse controller 160, which detects a print command from right-clicking, displays the print option setting selection screen on the display unit to allow a user to select a printer (output device 200) at the print output destination and print option setting (print condition) for the selected printer via the print option setting selection screen. Here, when selecting a print option setting (print condition), a user may simply just select a registered “setting name” to select the registered print option setting (print condition).

S13: At this point, transmitter/receiver 180 obtains information related to the status of the printer selected as an output destination (output device 200) by a user, and mouse controller 160 determines whether the selected printer is usable or unusable (for example, unusable due to a disconnection of communication with the selected printer or a device failure of the printer) based on the information obtained by transmitter/receiver 180. When the selected printer is determined to be usable, the processing proceeds to S15. When the selected printer is determined to be unusable, the processing proceeds to S14.

S14: When the selected printer is determined to be unusable, mouse controller 160 displays a setting name for the printer in an unselectable way on the print option setting selection screen, and the processing proceeds to S12. For example, a setting name for the printer is displayed in gray or the like on the display unit to inform a user that the setting name cannot be selected.

In this manner, mouse controller 160 as a setter disables use of the print condition (image processing condition) in connection with a setting name for a printer (output destination) to which the output of image data is determined to be impossible based on a result of acquisition by transmitter/receiver 180.

S15: Mouse controller 160, which determines that the selected printer is usable, displays the print option setting selection screen as selectable on the display unit.

The print option setting selection screen is, for example, print option setting selection screen 60 illustrated in FIG. 6 that displays names of printer drivers (PRINTER-1, PRINTER-2) that output print and setting names (double-sided short, two copies, double-sided long+toner saving) set on the print option setting screen so as to allow a user to select a print option. Here, FIG. 6 illustrates that “PRINTER-1” is selected as the name of the printer driver that outputs the print, and “double-sided long+toner saving” is selected as the setting name.

When mouse controller 160 receives an operation by a user to select a printer and a setting name via the print option setting selection screen, driver setting configurator 170 reads “login name” 151a and the details of “setting” 151c for “setting name” 151b. In other words, driver setting configurator 170 reads the setting information on each print setting item from setting-information table 151 illustrated in FIG. 4 which is registered in setting-information storage 150, “login name” 151a matching the login name currently logged in, and “setting name” 151b matching the selected setting name on the print option setting selection screen.

S16: Driver setting configurator 170 determines whether or not each item of the read setting information in print option setting can be used with printer driver 130 of the printer selected on the print option setting selection screen. When the read setting information is determined to be usable, the processing proceeds to S17. When at least one item of the read setting information in print option setting is unusable, the processing proceeds to S18.

S17: When the setting information in print option setting is determined to be usable, driver setting configurator 170 transfers the setting information in the print option setting as it is to the storage area referred by printer driver 130 corresponding to the selected printer, and the processing proceeds to S19.

S18: On the other hand, when at least one item of the setting information in print option setting is determined to be unusable, driver setting configurator 170 replaces the unusable setting information with usable setting information and transfers the setting information to the storage area referred by printer driver 130 corresponding to the selected printer, and the processing proceeds to S19.

S19: Driver setting configurator 170 launches application 120, and executes a print command.

S20: Printer driver 130, after generating print data as a command which is converted from a print document and analyzable by output device 200, analyzes the setting information transferred from the storage area by driver setting configurator 170, and inserts the command as a command in the header of the print data to generate the print data. Printer driver 130 passes the generated print data to transmitter/receiver 180 to request transmission of the print data.

S21: Transmitter/receiver 180, which receives a request for transmission, transmits the passed print data to the printer (output device 200) which is selected as the output destination.

S22: Transmitter/receiver 220 of output device 200 receives the print data transmitted from client PC 100, and passes the print data to print job controller 210. Print job controller 210 performs a rendering processing based on the passed print data to generate page data. Controller 210 further issues a print command to output unit 230 based on the command of the print option setting (print condition) which is inserted in the header of the print data by printer driver 130 of client PC 100.

S23: Output unit 230, which receives the print command from print job controller 210, outputs the print data, that is, prints page data, generated from the print data, according to the print option setting (print condition), and then the processing is terminated.

Here, an example of the above-mentioned print processing is described.

When the icon of a print target document, for example, “print document.txt” is right-clicked, for example, on Windows (registered trademark) and a batch file (for example, “double-sided long+toner saving.bat”) is selected via SendTo, the print option setting tool is called and the information on “print document.txt” and the setting parameters of “/PRINTER-1/double-sided printing/long-side binding/toner saving/tool priority” are passed to the print option setting tool.

The print option setting tool determines whether or not the passed setting parameters are a print option setting that is processable by “PRINTER-1” which is designated as the output destination or by application 120 (for example, a text editor) associated with “print document.txt”.

When the print option setting is determined to be processable, the print option setting tool specifies the setting parameters of “/double-sided printing/long-side binding/toner saving” as the print option setting of printer driver 130 corresponding to “PRINTER-1”, and sends the file storage location of “print document.txt” and the file name to application 120 and commands application 120 to print the file.

Application 120 (for example, a text editor) reads “print document.txt” and sends the data of “print document.txt” to printer driver 130 corresponding to “PRINTER-1” and commands printer driver 130 to print the data.

Printer driver 130 generates print data to be transmitted to output device 200, based on the data of “print document.txt” received from application 120 using the print option setting set by the print option setting tool.

In this manner, print option setter 140 of client PC 100 is able to register the print option setting set by an operation of a user in setting-information table 151 of setting-information storage 150. When a print target document is clicked and selected in client PC 100, mouse controller 160 allows a user to select, on print option setting selection screen 60, a desired print option setting (print condition) registered in setting-information table 151 of setting-information storage 150, thereby making it possible for the user to obtain a desired print result with a simple operation.

As described above, the first embodiment enables a user to select a pre-registered desired print option setting (print condition) when selecting and clicking a print target document, thereby achieving the effect that the user can obtain a desired print result by a simple operation.

### “Second Embodiment”

The configuration of a second embodiment is such that client PC of the first embodiment is further provided with a priority order setter. The configuration of the second embodiment is described with reference to the block diagram illustrating the configuration of an image processing system in the second embodiment of FIG. 7. Here, the same components as in the above-described first embodiment are denoted by the same symbol and a description thereof is omitted.

In FIG. 7, image processing system 1 includes client PC 100 that issues a print command as an image processing device, and output device 200 that is communicatively connected to client PC 100 via a communication line and that serves as an image formation device. In this embodiment, output device 200 is described as a printer.

Client PC 100 includes application 120, printer driver 130, print option setter 140, setting-information storage 150, mouse controller 160, driver setting configurator 170, transmitter/receiver 180, and priority order setter 190.

Priority order setter 190 performs priority order setting to specify a priority order of plural registered print option settings (print conditions) in accordance with an operation of a user.

Here, in this embodiment, plural print option settings include the print option setting pre-set in application 120 and the print option setting pre-set in printer driver 130 in addition to the print option setting set by print option setter 140.

The priority order setting performed by priority order setter 190 specifies one of plural print option settings to be used with the highest priority.

Thus, priority order setter 190 has a function as a third input unit that receives a selection from a user via a user interface (for example, a mouse) of one of the following print option settings (image processing condition): the print option setting set by print option setter 140, the print option setting pre-set in application 120, and the print option setting pre-set in printer driver 130.

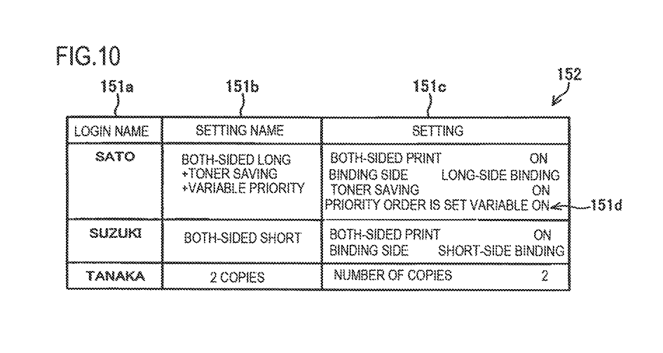

In this embodiment, for example, as illustrated in FIG. 10, setting-information table 151 stores “setting name” 151b as an identification information of the print option setting and “setting” 151c, which are the setting items of print option setting, in connection with “login name” 151a which is an identification information of a user. As compared with the first embodiment, a setting item of “priority order is set variable” 151d is added in “setting” 151c.

In this embodiment, “tool priority” is the setting specifying that the print option setting set by print option setter 140 is preferentially used, “application priority” is the setting specifying that the print option setting pre-set in application 120 is preferentially used, and “driver priority” is the setting specifying that the print option setting pre-set in printer driver 130 is preferentially used.

Next, the operation of the above-mentioned configuration is described.

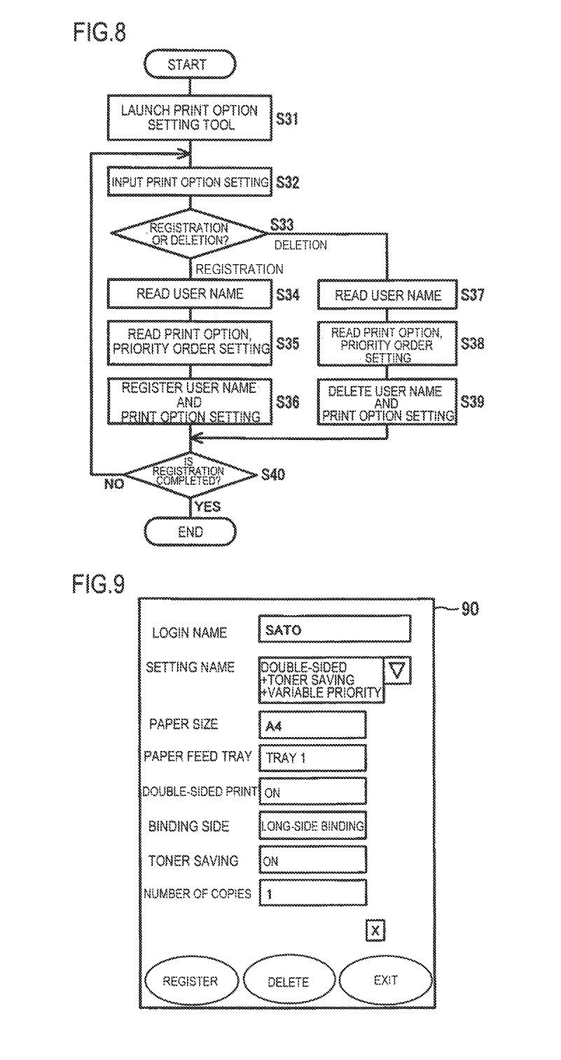

First, the processing of the print option setting performed by the image processing system is described with reference to FIG. 7 in accordance with the steps in FIG. 8 prefixed with the letter S in the flow chart illustrating the processing flow of print option setting in the second embodiment of FIG. 8.

S31: An operation of a user causes client PC 100 to launch a print option setting tool that is software for performing the print option setting. At this point, client PC 100 specifies printer driver 130 that performs the print option setting and launches the print option setting tool, and stores the driver name in setting-information storage 150.

Print option setter 140 of client PC 100, which has launched the software for performing the print option setting, and priority order setter 190 display a print option setting screen on a display unit such as a display in order to receive an operation on the print option setting by a user. The print option setting screen is, for example, print option setting screen 90 illustrated in FIG. 9, and includes a “registration” button, a “deletion” button, and an “exit” button. The “registration” button is for storing and registering setting information into setting-information storage 150. The “deletion” button is for deleting already registered setting information from setting-information storage 150, and the “exit” button is for exiting from print option setting screen 90. Here, the setting information is inputted to print setting items of the print option setting, such as “login name” for identifying a user, “setting name” for identifying a print option setting, “paper size” that specifies a size of paper to be printed, “paper feed tray” that specifies a paper feed tray that feeds paper, “double-sided print” that specifies double-sided print or single-sided print, “binding side” that specifies a side for binding, “toner saving” that specifies less toner consumption, “number of copies” that specifies the number of printed copies, and “setting priority order is made variable” (hereinafter referred to as “priority order setting”) for setting a variable priority order in print option setting.

In FIG. 9, “setting priority order is made variable” is set.

S32: Print option setter 140 and priority order setter 190 receive an operation with an input interface such as a keyboard, a mouse, or a touch panel to input any of setting items in the print option setting on the displayed print option setting screen.

In this manner, print option setter 140 prompts a user to input (a first input step) the first setting information (for example, information on performing double-sided printing) to be used by printer driver 130 and related to the first print setting item (for example, double-sided print/single-sided print). Print option setter 140 then prompts a user to input (a second input step) the second setting information (for example, information on performing long-side binding) to be used by printer driver 130 and related to the second print setting item (binding side) different from the first print setting item (for example, double-sided print/single-sided print).

In addition, print option setter 140 provides a setting name as the second identifier that connects the first setting information (for example, information on performing double-sided printing) with the second setting information (for example, information on performing long-side binding) (identifier providing step).

S33: Print option setter 140 determines whether the “registration” button or the “deletion” button is pressed in the print option setting screen. When it is determined that the “registration” button is pressed, the processing proceeds to S34. When it is determined that the “deletion” button is pressed, the processing proceeds to S37.

S34: Print option setter 140, which determines that the “registration” button is pressed, reads a “login name” that is inputted on the print option setting screen as a user name.

S35: Print option setter 140 further reads the setting name and the print option setting information including the priority order setting inputted on the print option setting screen.

S36: Print option setter 140 stores the read login name, setting name, and print option setting information including the priority order setting as “setting name” 151b and “setting” 151c in setting-information storage 150, and registers the login name and the print option setting information. The processing then proceeds to S40, “setting name” 151b and “setting” 151c being in connection with “login name” 151a of setting-information table 151.

In this manner, print option setter 140 registers an image processing condition with a provided setting name in readable setting-information storage 150 (registration step). Here, along with the image processing condition, the following are associated with each other: the printer driver name, the first setting information (for example, information on performing double-sided printing) and the second setting information (for example, information on performing long-side binding).

S37: On the other hand, print option setter 140, which determines that the “deletion” button is pressed in S33, reads a “login name” that is inputted on the print option setting screen as a user name.

S38: Print option setter 140 further reads the setting name and the print option setting information including the priority order setting inputted on the print option setting screen.

S39: Print option setter 140 erases (deletes) the “login name”, “setting name”, and print option setting information including the priority order setting inputted on the print option setting screen, from setting-information table 151 of setting-information storage 150, and the processing then proceeds to S40.

S40: Print option setter 140 determines whether or not the “exit” button is pressed on the print option setting screen. When the “exit” button is determined to be pressed, the processing is terminated. When the “exit” button is determined not to be pressed, the processing proceeds to S32 to wait for an input.

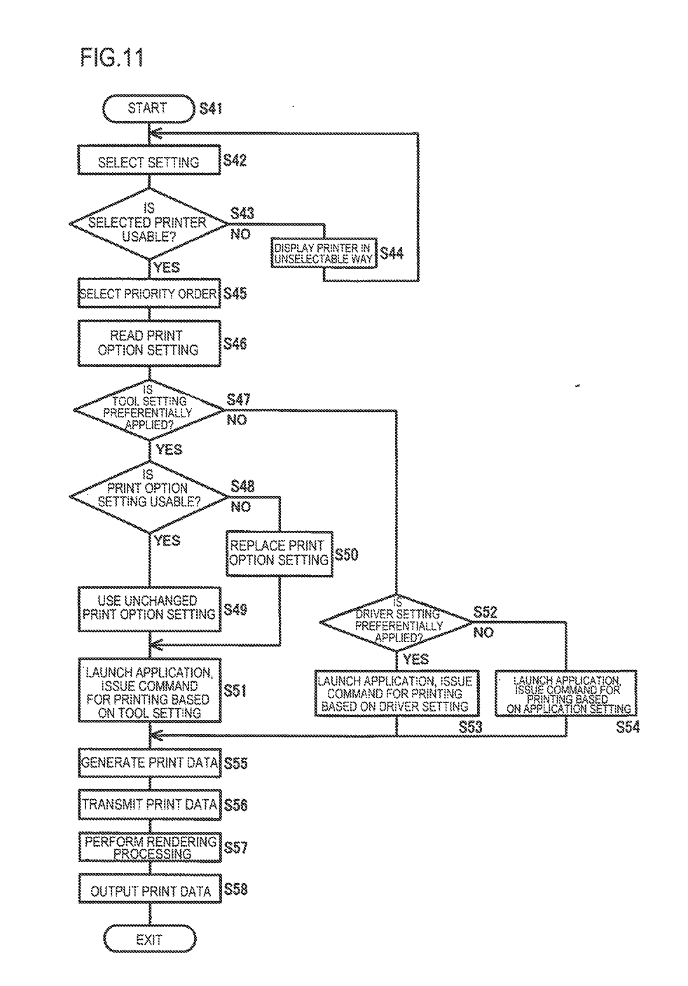

Next, the print processing performed by the image processing system is described with reference to FIG. 7 in accordance with the steps in FIG. 11 prefixed with the letter S in the flow chart illustrating the flow of print processing in the second embodiment of FIG. 11. It is assumed that a user has logged in the image processing system with a predetermined login name.

S41 to S44: The processing is the same as in S11 to S14 of FIG. 5, and a description thereof is omitted. S45: Subsequently, mouse controller 160 receives an operation of a user to select a priority order setting.

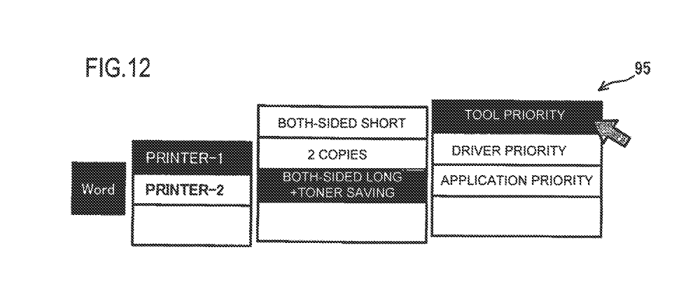

The print option setting selection screen is, for example, print option setting selection screen 95 illustrated in FIG. 12 that allows a user to select a printer driver (PRINTER-1, PRINTER-2) that output print, a setting name (double-sided short, two copies, double-sided long+toner saving) set on the print option setting screen, and a priority order setting (tool priority, driver priority, application priority). Here, FIG. 12 illustrates that “PRINTER-1” is selected as the name of the printer driver that outputs print, “double-sided long+toner saving” is selected as the setting name, and “tool priority” is selected as the priority order setting.

S46: When mouse controller 160 receives an operation by a user to select a printer, a setting name, and a priority order setting on the print option setting selection screen, driver setting configurator 170 reads “login name” 151a and “setting” 151c for “setting name” 151b. In other words, driver setting configurator 170 reads the print option setting information including priority order setting 151d (from setting-information table 151 illustrated in FIG. 10 which is registered in setting-information storage 150), “login name” 151a matching the login name currently logged in and “setting name” 151b matching the selected setting name on the print option setting selection screen.

S47: Driver setting configurator 170 determines whether or not the priority order setting included in the read print option setting information is “priority order is set variable” and the priority type selected on print option setting selection screen is tool priority. When the priority type is determined to be tool priority, the processing proceeds to S48. When the priority type is determined not to be tool priority, the processing proceeds to S52. When the priority order setting is not “priority order is set variable”, the processing is the same as in the first embodiment, and a description thereof is omitted.

S48 to S50: The processing is the same as in S16 to S18 of FIG. 5, and a description thereof is omitted.

S51: Driver setting configurator 170 launches application 120, and informs printer driver 130 of a print command for printing using (1) the print option setting set in the print option setting tool, and (2) printer driver 130 corresponding to the selected printer; and the processing proceeds to S55.

S52: Driver setting configurator 170, which determines that the priority type is not tool priority in S47, determines whether or not the priority type selected on the print option setting selection screen is driver priority. When the priority type is determined to be driver priority, the processing proceeds to S53. When the priority type is determined not to be driver priority, the processing proceeds to S54.

S53: Driver setting configurator 170, which determines that the priority type is driver priority, launches application 120, and informs printer driver 130 of a print command for printing using the print option setting set in printer driver 130 that corresponds to the selected printer, and the processing proceeds to S55.

S54: Driver setting configurator 170, which determines that the priority type is not driver priority, that is, application priority, launches application 120, and informs printer driver 130 of a print command for printing using (1) the print option setting set in application 120, and (2) printer driver 130 corresponding to the selected printer; and the processing proceeds to S55.

S55 to S58: The processing is the same as in S20 to S23 of FIG. 5, and a description thereof is omitted.

In this manner, any of “tool priority”, “application priority”, and “driver priority” is made selectable by an operation of a user, and thus operability by a user may be further improved. The “tool priority” specifying that the print option setting set by print option setter 140 is preferentially used, the “application priority” specifying that the print option setting pre-set in application 120 is preferentially used, and the “driver priority” specifying that the print option setting pre-set in printer driver 130 is preferentially used.

As described above, in the second embodiment, in addition to the effect of the first embodiment, a print option setting to be preferentially applied as a print condition may be selected by an operation of a user from the print option setting set by print setting option setter. The print option setting is pre-set in the application, and the print option setting is pre-set in the printer driver. Thus the effect is obtained in which operability by a user may be further improved.

It is to be noted that in the first embodiment and the second embodiment, a description is given by assuming the output device serving as an image formation device is a printer. However, without being limited to this, the output device may be a multifunction printer.

The invention includes other embodiments in addition to the above-described embodiments without departing from the spirit of the invention. The embodiments are to be considered in all respects as illustrative, and not restrictive. The scope of the invention is indicated by the appended claims rather than by the foregoing description. Hence, all configurations including the meaning and range within equivalent arrangements of the claims are intended to be embraced in the invention.

What is claimed is:

1. An image processing device comprising:
an image data output unit configured to perform image processing based on an image processing condition including plural print setting items and output image data to an output destination corresponding to the image data output unit;
a storage unit configured to store a first identifier, which is identification information of the image data output unit, when an image processing condition for the image data output unit is set;
a first input unit configured to prompt a user to input first setting information, which is setting information on a first print setting item of the image processing condition for the image data output unit;
a second input unit configured to prompt the user to input second setting information, which is print setting information on a second print setting item, different from the first print setting item, of the image processing condition for the image data output unit;
an identifier providing unit configured to provide a second identifier, which is an identification name of the image processing condition having the first and second setting information inputted through the first and second input units;
a registration unit configured to register the image processing condition having the second identifier, in connection with the first identifier, in a setting-information storage as a readable storage;
a first selection unit configured to receive selection of a print target;
a display unit configured to display the second identifier, which is provided to the image processing condition registered in the readable storage, on a display when the selection of the print target is received;
a second selection unit configured to receive selection of the second identifier displayed on the display by the display unit; and
an input unit configured to call the image data output unit having the first identifier being in connection with the second identifier selected by the second selection unit, and input, to the image data output unit having the first identifier, the image processing condition including the first and second setting information and information on the print target selected by the first selection unit,
wherein the image data output unit processes the information on the print target selected by the first selection unit, based on the image processing condition including the first and second setting information and provided with the inputted second identifier, and outputs the processed information as image data.

2. The image processing device according to claim 1, further comprising
an acquisition unit configured to acquire information on a status of the output destination corresponding to the image data output unit having the first identifier,
wherein, when output of image data to the output destination is determined to be impossible based on a result of the acquisition by the acquisition unit, the display unit changes display of the image processing condition having the second identifier being in connection with the first identifier of the output destination.

3. The image processing device according to claim 1, further comprising
a third input unit configured to prompt the user to select an image processing condition from: the image processing condition registered by the registration unit, an image processing condition pre-set by the image data output unit, and an image processing condition held by a processing unit being configured to output print data to the image data output unit and thereby cause the image data output unit to generate the image data,
wherein each of the image processing conditions includes the first setting information on the first print setting item and the second setting information on the second print setting item.

4. A computer implemented method of setting an image processing condition, the method comprising:
storing a first identifier, which is identification information of an image data output unit whose image processing condition including plural print setting items is to be set, the image data output unit being configured, based on the image processing condition, to output image data to an output destination corresponding to the image data output unit;
prompting a user to input first setting information, which is setting information on a first print setting item of the image processing condition for the image data output unit having the first identifier;
prompting the user to input second setting information, which is print setting information on a second print setting item, different from the first print setting item, of the image processing condition for the image data output unit having the first identifier;
providing a second identifier, which is an identification name of the image processing condition having the first and second setting information inputted through the first and second input units; and
registering the image processing condition having the second identifier, in connection with the first identifier, in a setting-information storage as a readable storage.

5. The method of setting an image processing condition according to claim 4, further comprising:
acquiring information on a status of the output destination corresponding to the image data output unit having the first identifier; and
when output of image data to the output destination is determined to be impossible based on a result of the acquisition by the acquisition unit, disabling use of the image processing condition having the second identifier and being in connection with the first identifier of the output destination.

6. The method of setting an image processing condition according to claim 4, further comprising:
prompting the user to select an image processing condition from an image processing condition registered by the registration unit, an image processing condition pre-set in the image data output unit, and an image processing condition held in advance by a processing unit being configured to output print data to the image data output unit, and thereby cause the image data output unit to generate the image data.

7. An image processing condition setting program stored in a non-transitory computer-readable recording medium executable by a computer, comprising:
a store unit configured to store a first identifier, which is identification information of an image data output unit whose image processing condition including plural print setting items is to be set, the image data output unit being configured, based on the image processing condition, to output image data to an output destination corresponding to the image data output unit;
a first input unit configured to prompt a user to input first setting information, which is setting information on a first print setting item of the image processing condition for the image data output unit having the first identifier;
a second input unit configured to prompt the user to input second setting information, which is print setting information on a second print setting item, different from the first print setting item, of the image processing condition for the image data output unit having the first identifier;
an identifier providing unit configured to provide a second identifier, which is an identification name of the image processing condition having the first and second setting information inputted through the first and second input units; and
a registration unit configured to register the image processing condition having the second identifier, in connection with the first identifier, in a setting-information storage as a readable storage.

8. The image processing condition setting program according to claim 7, further comprising:
an acquisition unit configured to acquire information on a status of the output destination corresponding to the image data output unit having the first identifier; and
a setting unit configured to, when output of image data to the output destination is determined to be impossible based on a result of the acquisition by the acquisition unit, disable use of the image processing condition having the second identifier and being in connection with the first identifier of the output destination.

9. The image processing condition setting program according to claim 7, further comprising:
a third input unit configured to prompt the user to select an image processing condition from the image processing condition registered by the registration unit, an image processing condition pre-set in the image data output unit, and an image processing condition held in advance by a processing unit being configured to output print data to the image data output unit, and thereby cause the image data output unit to generate the image data.
